(19) United States
(12) Patent Application Publication
(10) Pub. No.: US 2020/0049159 A1
(43) Pub. Date: Feb. 13, 2020

(54) AXIAL FLOW FAN

(71) Applicant: Acer Incorporated, New Taipei City (TW)

(72) Inventors: Kuang-Hua Lin, New Taipei City (TW); Cheng-Wen Hsieh, New Taipei City (TW); Wen-Neng Liao, New Taipei City (TW)

(73) Assignee: Acer Incorporated, New Taipei City (TW)

(21) Appl. No.: 16/199,232

(22) Filed: Nov. 26, 2018

(30) Foreign Application Priority Data
Aug. 13, 2018 (TW) 107128177

(51) Int. Cl. F04D 29/38

(52) U.S. Cl. CPC F04D 29/384; F05D 2260/96; F05D 2240/301; F04D 29/388

(57) ABSTRACT

An axial flow fan includes a hub and a plurality of fan blade sets. The hub is configured to rotate around an axis. The fan blade sets are disposed at the peripheral of the hub, wherein each of the fan blade sets includes a first fan blade and a second fan blade arranged side by side along the axis and a flow channel is defined by each of the first fan blades and the corresponding second fan blade. Each of the flow channels has an inlet and an outlet opposite to each other, wherein at least one of each of the first fan blades and the corresponding second fan blade has a flow guiding hole and each of the flow guiding holes is located between the inlet and the outlet. Each of the flow guiding holes is communicated with the flow channel.

### CROSS-REFERENCE TO RELATED APPLICATION

This application claims the priority benefit of Taiwan application serial no. 107128177, filed on Aug. 13, 2018. The entirety of the above-mentioned patent application is hereby incorporated by reference herein and made a part of this specification.

### BACKGROUND

### Technical Field

The disclosure relates to a fan, and more particularly to an axial flow fan.

### Description of Related Art

With the development of technology, centrifugal fans and axial flow fans have become more and more widely used for heat dissipation in technological products. Take the axial flow fan as an example, the flow direction of the airflow generated during operation of the axial flow fan is theoretically parallel to an axis which served as a rotational reference of the axial flow fan.

However, during the actual operation of the axial flow fan, part of the airflow flowing past a flow channel between two fan blades is guided by the fan blades and flows out of the flow channel along the flow direction non-parallel to the axis, causing the axial flow rate of the airflow generated during the operation of the axial flow fan to be insufficient. On the other hand, in order to increase wind pressure to satisfy products with high demand for heat dissipation, the number of fan blades of the axial flow fan is constantly increasing. However, having too many fan blades causes the distance between two adjacent fan blades to be overly close, resulting in airflow disturbance and friction with the blade surfaces of the fan blades, thereby increasing the noise at work.

### SUMMARY

The disclosure provides an axial flow fan which can increase axial flow rate and reduce noise production.

The axial flow fan of the disclosure includes a hub and multiple fan blade sets. The hub is configured to rotate around an axis. The multiple fan blade sets are disposed at the peripheral of the hub, wherein each of the fan blade sets includes a first fan blade and a second fan blade arranged side by side along the axis. A flow channel is defined by each of the first fan blades and the corresponding second fan blade. Each of the flow channels has an inlet and an outlet opposite to each other, wherein at least one of each of the first fan blades and the corresponding second fan blade is provided with a flow guiding hole. Each of the flow guiding holes is located between the inlet and the outlet of the corresponding flow channel. Each of the flow guiding holes is communicated with the corresponding flow channel.

Based on the above, each of the fan blade sets of the axial flow fan of the disclosure is provided with at least one flow guiding hole for increasing the flow rate of airflow into the flow channel of each of the fan blade sets. The airflow flowing past the flow channel of each of the fan blade sets may be ejected from the outlet of the flow channel. The flow direction of the airflow ejected from the outlet of the flow channel is parallel to the hub as the axis of rotational reference. Therefore, the axial flow fan of the disclosure not only increases the axial flow rate, but also prevents the airflow disturbance to reduce noise produced during the operation of the axial flow fan.

To make the aforementioned and other features of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a structure of an axial flow fan according to the first embodiment of the disclosure.

FIG. 2 is a schematic side view of the axial flow fan according to the first embodiment of the disclosure.

FIG. 3 is a schematic cross-sectional view of any one of fan blade sets according to the first embodiment of the disclosure.

FIG. 4 is a schematic side view of an axial flow fan according to the second embodiment of the disclosure.

FIG. 5 is a schematic side view of an axial flow fan according to the third embodiment of the disclosure.

FIG. 6 is a schematic view of a structure of an axial flow fan according to the fourth embodiment of the disclosure.

### DETAILED DESCRIPTION OF DISCLOSED EMBODIMENTS

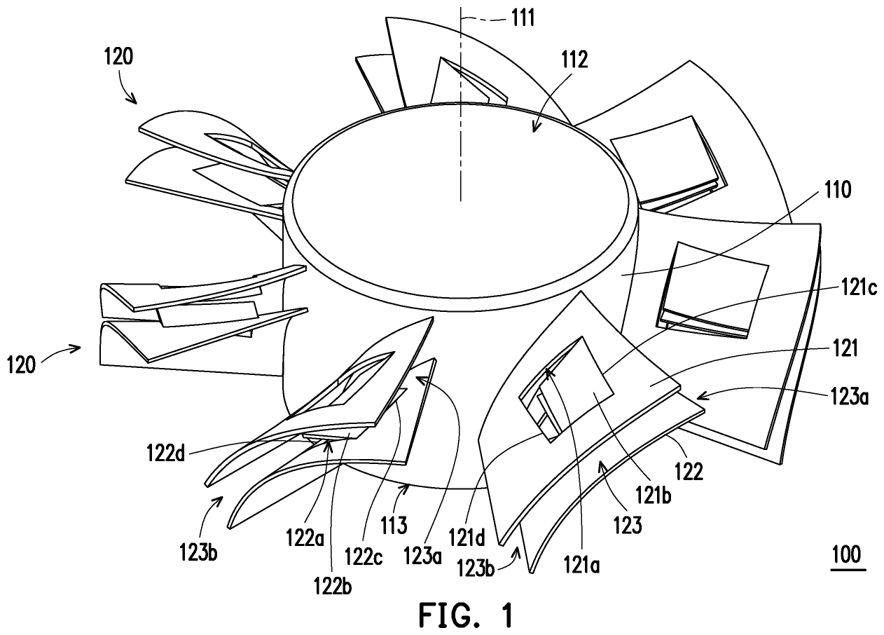

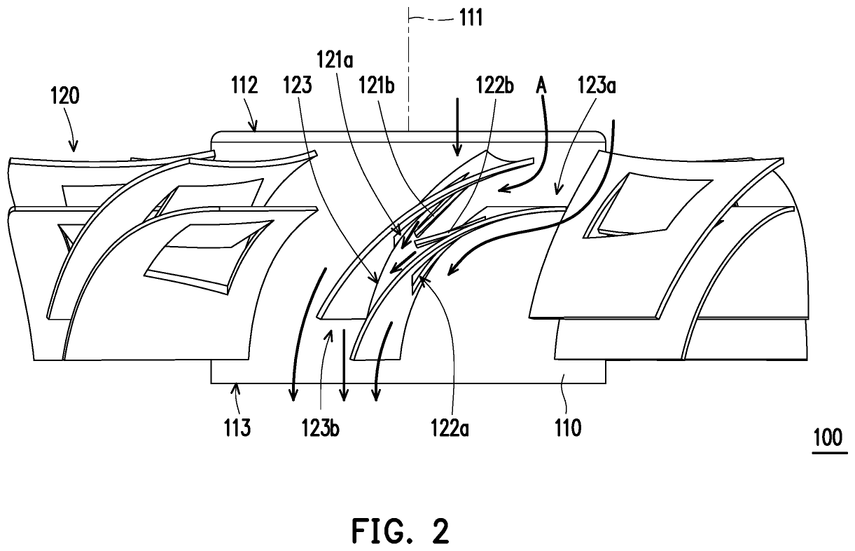

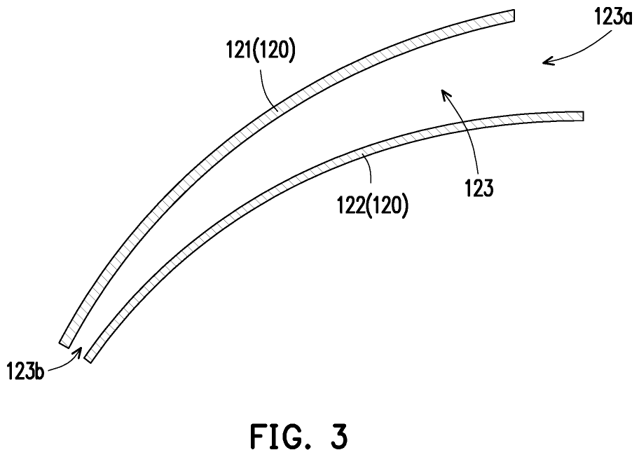

FIG. 1 is a schematic view of a structure of an axial flow fan according to the first embodiment of the disclosure. FIG. 2 is a schematic side view of the axial flow fan according to the first embodiment of the disclosure. FIG. 3 is a schematic cross-sectional view of any one of fan blade sets according to the first embodiment of the disclosure. Here, the cross section of FIG. 3 is parallel to an axis 111 of a hub 110, and flow guiding portions 121a and 122a are omitted. Please refer to FIG. 1 to FIG. 2 first, in the embodiment, an axial flow fan 100 may include the hub 110 and a plurality of fan blade sets 120. The fan blade sets 120 are, for example, sequentially arranged in a counterclockwise or a clockwise direction along the peripheral of the hub 110 and surround the axis 111 which served as a rotational reference of the hub 110. On the other hand, the fan blade sets 120 may adopt metal fan blades to meet the design requirement of thinning, but is not limited to such. In other embodiments, the material of the fan blade sets may be plastic, acrylic, carbon fiber, or other suitable materials.

Using one of the fan blade sets 120 for illustration, the fan blade set 120 includes a first fan blade 121 and a second fan blade 122 arranged side by side along the axis 111. The first fan blade 121 and the second fan blade 122 overlap with each other on the axis 111, and a flow channel 123 is defined therebetween. The hub 110 has a top 112 and a bottom 113 opposite to each other. The first fan blade 121 and the second fan blade 122 are arranged side by side between the top 112 and the bottom 113, and the first fan blade 121 is located between the top 112 and the second fan blade 122. On the other hand, the flow channel 123 has an inlet 123a and an outlet 123b opposite to each other. The inlet 123a is close to the top 112 and the outlet 123b is close to the bottom 113. During the operation of the axial flow fan 100, the hub 110 rotates around the axis 111, and the fan blade set 120 rotates together with the hub 110, thereby causing an airflow A. Furthermore, the airflow A may flow from the top 112 of the hub 110 into the flow channel 123 via the inlet 123a. Next, the airflow A in the flow channel 123 flows toward the outlet 123b and flows out of the flow channel 123 via the outlet 123b, and further flows toward the bottom 113 of the hub 110. In addition, the airflow A may also flow from the top 112 of the hub 110 into between two adjacent fan blade sets 120, and further flows toward the bottom 113 of the hub 110.

In the embodiment, the first fan blade 121 and the second fan blade 122 disposed in sets are respectively provided with flow guiding holes 121a and 122a. The flow guiding holes 121a and 122a are both communicated with the flow channel 123, and the flow guiding holes 121a and 122a are both located between the inlet 123a and the outlet 123b of the flow channel 123. Based on the design of the flow guiding holes 121a and 122a, the airflow A flowing past between the two adjacent fan blade sets 120 may flow into the flow channel 123 via the flow guiding hole 121a or the flow guiding hole 122a to increase the flow rate of the airflow A flowing past the flow channel 123 and to prevent the airflow A from disturbing between the two adjacent fan blade sets 120, thereby reducing the noise produced during the operation of the axial flow fan 100.

Furthermore, the first fan blade 121 and the second fan blade 122 are respectively provided with flow guiding portions 121b and 122b. The flow guiding portion 121b extends into the flow channel 123 via the flow guiding hole 121a and the flow guiding portion 122b extends into the flow channel 123 via the flow guiding hole 122a. The flow guiding hole 121a and the flow guiding hole 122a overlap with each other on the axis 111.

Also, the flow guiding portion 121b and the flow guiding portion 122b overlap with each other on the axis 111, but the flow guiding portion 121b is kept at a distance from the flow guiding portion 122a to allow the airflow A to pass smoothly.

Furthermore, the flow guiding portions 121b and 122b extended into the flow channel 123 both extend toward the outlet 123b. The flow guiding hole 121a has a first inner edge 121c and a second inner edge 121d opposite to each other and arranged side by side between the inlet 123a and the outlet 123b. The first inner edge 121c is located between the second inner edge 121d and the inlet 123a. Similarly, the flow guiding hole 122a has a first inner edge 122c and a second inner edge 122d opposite to each other and arranged side by side between the inlet 123a and the outlet 123b. The first inner edge 122c is located between the second inner edge 122d and the inlet 123a. On the other hand, the flow guiding portion 121b is connected to the first inner edge 121c and extends toward the outlet 123b. Similarly, the flow guiding portion 122b is connected to the first inner edge 122c and extends toward the outlet 123b. Based on the design of the flow guiding portions 121b and 122b, the airflow A flowing past the flow guiding hole 121a or the flow guiding hole 122a may be guided into the flow channel 123 by the flow guiding portion 121b or the flow guiding portion 122b. Also, the airflow A flowed into the flow channel 123 may be ensured to flow toward the outlet 123b.

Please refer to FIG. 1 to FIG. 3, in the embodiment, the distance between the first inner edge 121c and the inlet 123a is less than the distance between the second inner edge 121d and the outlet 123b. Similarly, the distance between the first inner edge 122c and the inlet 123a is less than the distance between the second inner edge 122d and the outlet 123b. On the other hand, the aperture of the flow channel 123 is gradually decreased from the inlet 123a to the outlet 123b. In other words, the flow channel 123 has multiple cross sections parallel to the axis 111, and the areas of the cross sections closer to the inlet 123a is larger than the areas of the cross sections closer the outlet 123a.

Based on Bernoulli's principle, the airflow A in the flow channel 123 is continuously accelerated during the flow from the inlet 123a to the outlet 123a, and is finally ejected from the outlet 123a. Also, the flow direction of the airflow A ejected from the outlet 123a is parallel to the axis 111 of the hub 110. Next, since the flow guiding holes 121a and 122a are both disposed close to the inlet 123a, the airflow A flowed into the flow channel 123 via the flow guiding hole 121a or the flow guiding hole 122a may obtain a larger amount of increase in flow velocity. On the other hand, in the case when the flow velocity of the airflow A at the outlet 123a is large, the pressure at the outlet 123a is lower than that of the surrounding, so the airflow A of the surrounding can be guided toward the outlet 123a to reduce the generation of non-axial airflow and improve the axial flow rate.

Other embodiments will be exemplified below for illustration. Only the differences between the embodiments will be illustrated, and same or similar structural designs and operational principles will not be reiterated.

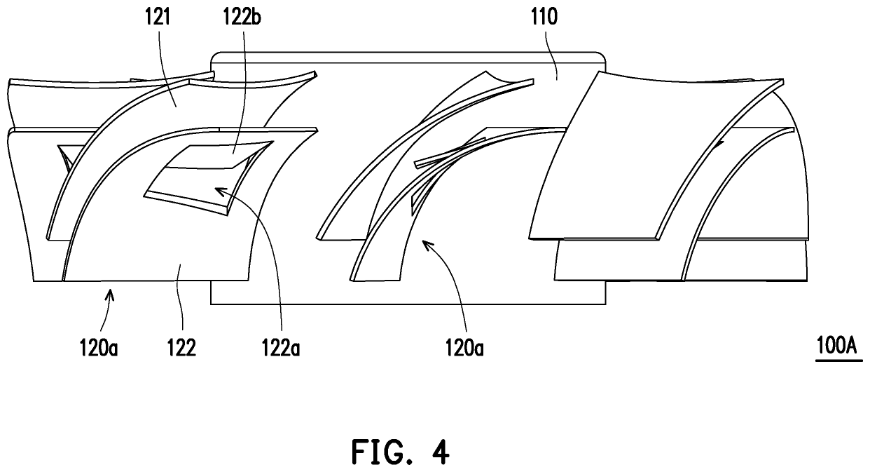

FIG. 4 is a schematic side view of an axial flow fan according to the second embodiment of the disclosure. Please refer to FIG. 4, the difference between an axial flow fan 100A of the embodiment and the axial flow fan 100 of the first embodiment is: the first fan blade 121 of a fan blade set 120a is not provided with a flow guiding hole or a flow guiding portion.

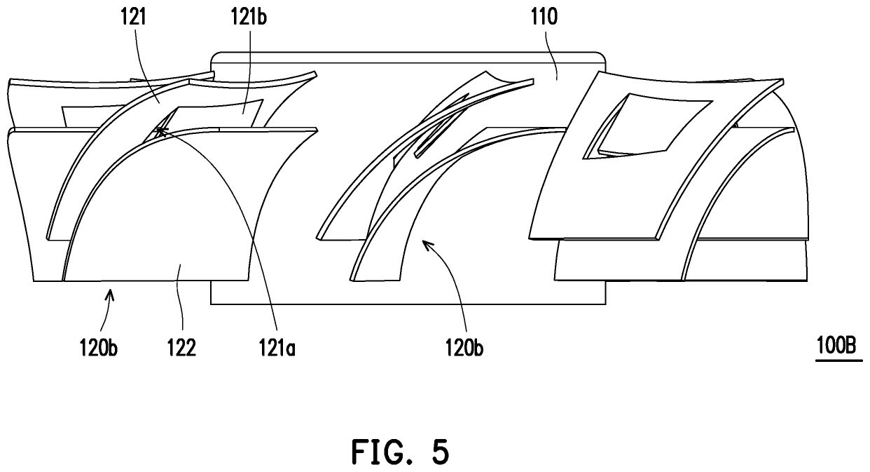

FIG. 5 is a schematic side view of an axial flow fan according to the third embodiment of the disclosure. Please refer to FIG. 5, the difference between an axial flow fan 100B of the embodiment and the axial flow fan 100 of the first embodiment is: the second fan blade 122 of a fan blade set 120b is not provided with a flow guiding hole or a flow guiding portion.

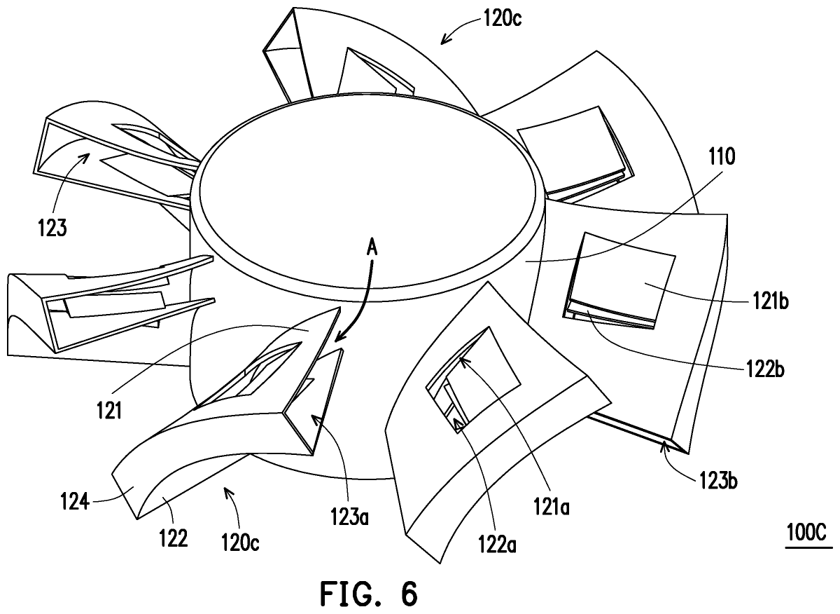

FIG. 6 is a schematic view of a structure of an axial flow fan according to the fourth embodiment of the disclosure. Please refer to FIG. 6, the difference between an axial flow fan 100C of the embodiment and the axial flow fan 100 of the first embodiment is: a fan blade set 120c further includes a side wall 124 configured to connect the first fan blade 121 and the second fan blade 122, and the flow guiding holes 121a and 122a are located between the hub 110 and the side wall 124. In other words, the first fan blade 121 and the second fan blade 122 respectively have side edges that are relatively far from the hub 110, and the side wall 124 connects the two side edges which are arranged side by side to ensure that the airflow A in the flow channel 123 flows from the inlet 123a toward the outlet 123b.

Based on the above, each of the fan blade sets of the axial flow fan of the disclosure is provided with at least one flow guiding hole for increasing the flow rate of the airflow into the flow channel of each of the fan blade sets. The aperture of the flow channel of each of the fan blade sets is gradually decreased from the inlet to the outlet to allow the airflow flowing past the flow channel of each of the fan blade sets to be accelerated and ejected from the outlet of the flow channel. The flow direction of the airflow ejected from the outlet of the flow channel is parallel to the axis which served as the rotational reference of the hub. Therefore, the axial flow fan of the disclosure not only increases the axial flow rate, but also prevents the airflow disturbance to reduce the noise produced during the operation of the axial flow fan.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An axial flow fan comprising:
a hub, configured to rotate around an axis; and
a plurality of fan blade sets, disposed at the peripheral of the hub, wherein each of the fan blade sets comprises a first fan blade and a second fan blade arranged side by side along the axis, and a flow channel is defined by each of the first fan blades and the corresponding second fan blade, each of the flow channels has an inlet and an outlet opposite to each other, wherein at least one of each of the first fan blades and the corresponding second fan blade is provided with a flow guiding hole, and each of the flow guiding holes is located between the corresponding inlet and the corresponding outlet, each of the flow guiding holes is communicated with the corresponding flow channel.

2. The axial flow fan according to claim 1, wherein at least one of each of the first fan blades and the corresponding second fan blade is provided with a flow guiding portion, which extends into the corresponding flow channel via the corresponding flow guiding hole.

3. The axial flow fan according to claim 2, wherein each of the flow guiding portions extends toward the outlet in the corresponding flow channel.

4. The axial flow fan according to claim 2, wherein each of the flow guiding holes has a first inner edge and a second inner edge opposite to each other and arranged side by side between the inlet and the outlet, each of the first inner edges is located between the corresponding second inner edge and the inlet, and each of the flow guiding portions is connected to the corresponding first inner edge.

5. The axial flow fan according to claim 1, wherein an aperture of each of the flow channels is gradually decreased from the inlet to the outlet.

6. The axial flow fan according to claim 1, wherein each of the flow guiding holes has a first inner edge and a second inner edge opposite to each other and arranged side by side between the inlet and the outlet, each of the first inner edges is located between the corresponding second inner edge and the inlet, and a distance between each of the first inner edges and the corresponding inlet is less than a distance between the corresponding second inner edge and the outlet.

7. The axial flow fan according to claim 1, wherein each of the fan blade sets further comprises a side wall configured to connect the corresponding first fan blade and the corresponding second fan blade, and each of the flow guiding holes is located between the hub and the corresponding side wall.
